(19) United States
(12) Patent Application Publication
(10) Pub. No.: US 2007/0221002 A1
(43) Pub. Date: Sep. 27, 2007

(54) ROLLER SCREW MECHANISM

(76) Inventor: Hung-sung PAN, Taichung (TW)

Correspondence Address: BANGER SHIA, 204 CANYON CREEK, VICTORIA, TX, 77901, US

(21) Appl. No.: 11/277,528

(22) Filed: Mar. 27, 2006

(51) Int. Cl. F16H 1/24; F16H 55/02

(52) U.S. Cl. 74/424.82

(57) ABSTRACT

A roller screw mechanism, the return path includes a linear section and two curved return sections. Set the requirement angle of the rollers return path separately into two return path of the return pieces. The circulation components made by injection molding or casting. The linear section is made by composing the fillister of the screw nut and a cap, and the return pieces are fixed by the cap to make entire path easy to manufacture and assemble. The linear section is set in the nut, and two curved return sections are connect the both ends of the linear section and the helical groove to shorten the entire circulation path and sure the section shape to increase the effect of smooth motion.

### BACKGROUND OF THE INVENTION

1. Field of the Invention

The present invention relates to a roller screw mechanism, and more particularly to an easily assembled and manufactured roller screw mechanism that can improve the returning motion smoothness.

2. Description of the Prior Art

The structure of a ball screw is mainly that in both the nut and the screw shaft are correspondingly formed with helical grooves, and a plurality of balls are received in the helical grooves of the nut. A circulation path is defined in the nut for enabling the plurality of balls to circulate endlessly, and the balls are used as motion-transmitting medium between screw shaft and the nut, so that the ball screw can operate with low friction and achieve a high precision positioning function.

It should be noted that the balls are in point contact with the helical grooves. According to Hertzian contact theory, the balls are in point contact with the helical grooves, the resultant contacting surface is small, and therefore, the bearing capacity is relatively low. Such design is suitable for being used in high axial loading situations. Therefore, some people in the art propose a design of forming a roller screw mechanism by replacing the roller with ball. For example, U.S. Pat. Nos. 3,055,230, 3,192,791 and 6,481,305 disclose a roller screw mechanism.

Since the rollers have to be circulated endlessly in the nut, the nut must be defined with a circulation path. The three aforesaid US Pts all additionally install a return pipe on the nut as a roller circulation path. As shown in FIG. 1, in a space between the V-shaped helical grooves 11 and 21 being formed correspondingly in the screw shaft 1 and the nut 2 can be received a plurality of rollable rollers 3. Both ends of the helical groove 21 of the nut 2 are connected by a return pipe 22, and a fixing member 23 is used to return pipe 22, so that the plurality of rollers 3 can roll endlessly in the circulation path formed by the V-shaped helical grooves 11 and 21 and the return pipe 22.

However, the return pipe 2 itself for connecting both ends of the helical groove is not only winding but also must be bent 90 degrees, then the rollers can re-enter the helical groove at a right angle after circulation. Producing such a structure is not easy. Due to the return pipe 22 must be bent by a pipe whose inner hole having a square cross section, the inner hole of the return pipe 22 may be deformed after bending operation, causing interference during the rolling of the rollers, or even worse, stopping the traversing of the rollers.

Furthermore, to prevent the inner hole from being deformed overly by an excessive bending of the return pipe 22, and from affecting the rolling of the rollers, the return pipe 22 usually will protrude a certain distance out of the return pipe 22. By such arrangement, the total length of the return pipe 22 will be lengthened, namely, the number of the rollers 3 in the return pipe 22 will be increased. However, the rollers 3 in the return pipe 22 are in an unloaded condition and must be pushed to move by rollers 3 that are in a loaded condition in the helical grooves 11 and 21. Therefore, the more rollers 3 in the return pipe 22, the more difficult the circulation of the rollers will be, thus affecting the rolling smoothness of the rollers.

In addition, the design of the return pipe 22 protruding out of the nut has such a problem that the return pipe 22 is likely to be impacted and deformed by external force, causing interference to the rolling of the rollers, or even worse, the rollers will be blocked.

Of course, there are some solutions to the return pipe (outer circulation) in the field of the ball screw that is similar to the roller screw mechanism, it usually takes the design of inner circulation or end cap circulation. The inner circulation or the end cap circulation gives up the return pipe and has the return path formed in the nut directly. However, using such design directly on the roller screw mechanism is difficult.

The reason is because the rolling ball is a spherical structure, its cross section is circular, in other words, the circulation path can be formed just by drilling a hole in the nut. However, the roller is a cylindrical structure and the cross section of the circulation path is square-shaped. Hence, the method of forming circulation path in the ball screw cannot be directly used on the roller screw mechanism.

In general, the design of using the return pipe as a roller circulation device not only makes the production difficult, but also will affect the rolling smoothness of the roller, therefore, it needs to be improved.

The present invention has arisen to mitigate and/or obviate the afore-described disadvantages.

### SUMMARY OF THE INVENTION

The primary objective of the present invention is to solve the aforesaid problems by providing an easily assembled roller screw mechanism that can improve the smoothness of the return motion of the rollers by shortening the roller's return path.

The secondary objective of the present invention is that the respective return pieces are formed with a protruding scoop that extends to the helical groove of the screw shaft, and the scoop is parallel to the direction of the tangent line of the helical groove of the screw shaft, so as to improve the smoothness of the return motion of the rollers.

To achieve the abovementioned objectives, the present invention sets the roller circulation path in the nut, the circulation path includes a linear section and two curved return sections. The linear section axially extends into the nut, each of the two curved return sections is formed in a return piece and fixed at either end of the helical groove of the nut respectively, whereby to join the curved return sections to both ends of the helical groove of the nut, a cross section of the respective curved return sections is rectangular for enabling the rollers to roll thereon.

The present invention sets the requirement angle of the roller return path dispersedly into the curved return sections of two return pieces, the return pieces can be formed by injection molding or casting. The linear section of the return path can be machined in the nut directly, and the cap is used to fix the two return pieces, so as to make the entire circulation path easy to assemble and manufacture.

In addition, the design of the circulation path of the present invention can reduce the length of the return path effectively, so that the number of the rollers in an unloaded condition can be reduced, thus improving the smoothness of return motion of the rollers.

Moreover, the respective return pieces are formed at the conjunction between the curved return section and the helical groove thereof with a protruding scoop that extends to the helical groove of the screw shaft. The cross section of the scoop is located in the direction of the tangent line of the helical groove of the screw shaft, so that the rollers can be introduced smoothly into the curved return sections by the scoop, accordingly improving the smoothness of the return motion of the rollers.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an illustrative view of showing a conventional roller screw with a return pipe;

FIG. 2 is a perspective view of a roller screw in accordance with the present invention;

FIG. 3 is an exploded view of a nut in accordance with the present invention; and

FIG. 4 is an illustrative view in accordance with the present invention of showing the return piece that cooperates with the nut.

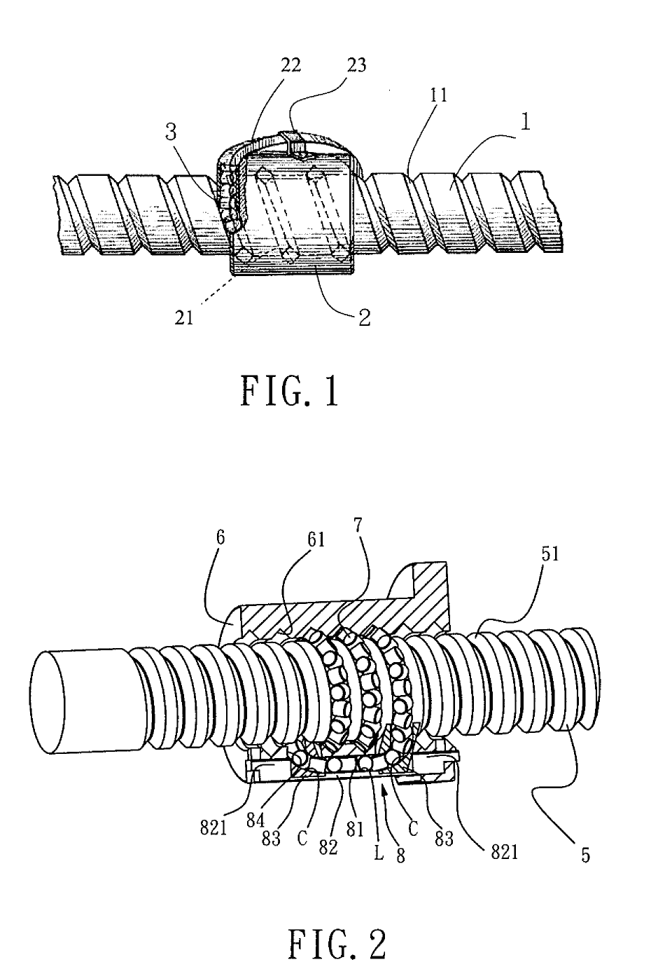

### DETAILED DESCRIPTION OF THE PREFERRED EMBODIMENT

The foregoing, and additional objects, features and advantages of the present invention will become apparent from the following detailed description of preferred embodiments thereof, taken in conjunction with the accompanying drawings.

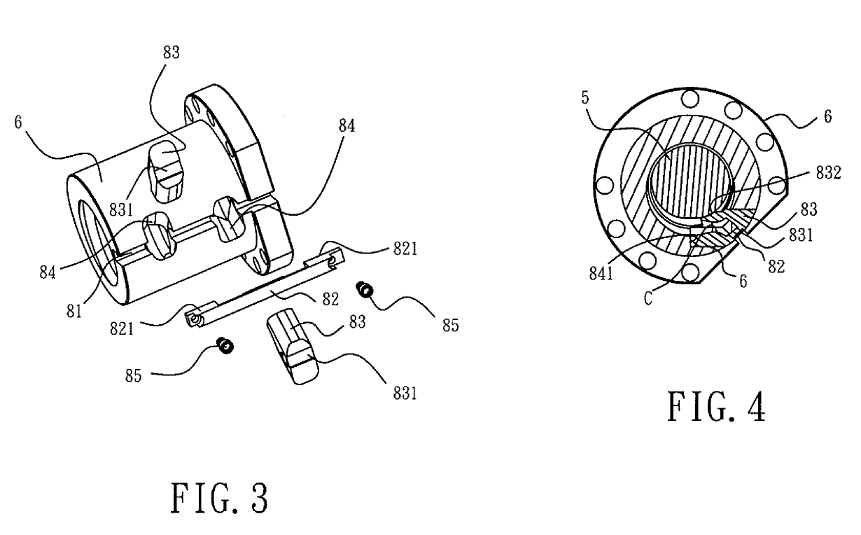

Refer firstly to FIGS. 2-4, which show a first embodiment of the present invention. The roller screw mechanism in this embodiment comprises a screw shaft 5, a nut 6 and a plurality of rollers 7, and the rollers 7 in this embodiment are arranged in a cross fashion.

The screw shaft 5 is formed in its outer surface with a helical groove 51 that is V-shaped in cross section. The nut 6 cooperates with the screw shaft 5 and is provided for insertion of the screw shaft 5. In the inner surface of the nut 6 is formed a helical groove 61 that is V-shaped in cross section and is aligned to the helical groove 51 of the screw shaft 5. In the nut 6 is defined a return path 8 that is connected to both ends of the helical groove 61, forming a complete circulation path in which the plurality of rollers 7 are disposed, so that the rollers 7 can roll endlessly in the nut 6, serving as a motion-transmitting medium between the nut 6 and the screw shaft 5.

The return path 8 includes a linear section L and two curved return sections C, and the two curved return sections C are located at both ends of the linear section L and are connected to both ends of the helical groove 61, forming a complete circulation path.

The linear section L axially extends into the nut 6, in this embodiment, in the outer surface of the nut 6 is formed an axially extending rectangular fillister 81, and a cap 82 is arranged correspondingly to the rectangular fillister 81. The cap 82 is formed at either end thereof with a protrusion 821, so that when the cap 82 is fixed in the rectangular fillister 81, the linear section L of the circulation path having a rectangular cross section can be formed between the rectangular fillister 81 and the cap 82, permitting the rollers 7 to roll therein.

Each of the two curved return sections C is formed in a return piece 83. In this embodiment, the curved return section C in the respective return pieces 83 is approximately bent 90 degrees, and the rectangular cross section of the respective curved return sections C is bent 45 degrees.

The respective return pieces 83 are fixed at both ends of the helical groove 61 of the nut 6. In this embodiment, the nut 6 is defined from with two receiving grooves 84 that are formed from the inside to the outside thereof and are located correspondingly to both ends of the helical groove 61. The receiving grooves 84 are connected to the linear section L (the rectangular fillister 81) of the return path 8, and the respective receiving grooves 84 do not fully penetrate the nut 6, so as to form a stop portion 841 at the conjunction between the receiving grooves 84 and the inner surface of the nut 6. The cross section of the respective receiving grooves 84 cooperates with the respective return pieces 83 for enabling the respective return pieces 83 to be inserted from outside into the receiving grooves 84, and the respective return pieces 83 will be positioned after being stopped by the respective stop portions 841. Thus enable the curved return sections C of the respective return pieces 83 to be connected at both ends of the linear section L thereof.

The rectangular fillister 81 and the respective return pieces 83 are located in the same straight line, therefore, the cap 82 can straddle the respective return pieces 83. The respective return pieces 83 are formed with a recess 831 in which the cap 82 can be engaged, so that the respective return pieces 83 can be fixed by the cap 82.

In addition, the respective return pieces 83 are formed at the conjunction between the curved return section C and the helical groove 61 thereof with a protruding scoop 832 that extends to the helical groove 51 of the screw shaft 5. The tangent surface of the scoop 832 is located in the direction of the tangent line of the helical groove 51 of the screw shaft 5, so that the rollers 7 can be introduced into the curved return sections C by the scoop 832. In this way, the rollers 7 can roll endlessly within the circulation path formed by the return path 8 and the helical grooves 51 and 61.

The solution of the present invention to the problem of the conventional return pipe is still to install the return path 8 in the nut. However, the cross section of the roller circulation path must be rectangular, it is impossible to be formed by the method of hole drilling. Hence, the present invention makes an axially-extending rectangular fillister 81 in the outer surface of the nut 6 by milling, cutting, etc. However, the rectangular fillister 81 opens from inside to outside, so it cannot be directly used as a rolling passage of the rollers 7. In this case, the present invention then installs a cap 82 in the rectangular fillister 81, and at either end of the cap 82 is formed a protrusion 821, so that when the cap 82 is fixed in the rectangular fillister 81, a linear section L of the circulation path being rectangular in cross section can be formed between the rectangular fillister 81 and the cap 82, serving as a rolling passage for the rollers 7. Such a design facilitates production very much.

The two ends of the linear section L of the return path 8 and the helical groove 61 is jointed by the curved return sections C. The curved return sections C are formed in the return pieces 83. Since the rollers 7 in returning course are in an unloaded condition, the return pieces 83 can be formed by injection molding or casting. As a result, it is easily to form the curved return sections C having rectangular cross section in the return pieces 83. By such arrangements, the two curved return sections C and the linear section L can form the return path 8 for circulating the rollers 7.

For facilitating assembly, the respective receiving grooves 84 of the present invention do not penetrate the nut 6 completely, so as to form the stop portion 841 at the conjunction between the receiving grooves 84 and the inner surface of the nut 6, providing a positioning effect to the return pieces 83 engaged in the receiving grooves 84. Moreover, the rectangular fillister 81 and the respective return pieces 83 are located in the same straight line, therefore, the cap 82 can straddle the respective return pieces 83. In this way, the cap 82 can fix the two return pieces 83 simultaneously, making the assembly easy.

Since the return path 8 of the present invention is set in the nut 6, the travel of the entire return path 8 will be very much shortened relative to the return pipe of the prior art. And as a result, the number of the rollers in an unloaded condition can be reduced, thus improving the smoothness of the return motion of the rollers 7.

In addition, the respective return pieces 83 is formed at the conjunction between the curved return section C and the helical groove 61 thereof with a protruding scoop 832 that extends to the helical groove 51 of the screw shaft 5. The tangent surface of the scoop 832 is located in the direction of the tangent line of the helical groove 51 of the screw shaft 5, so that the rollers 7 can be introduced smoothly into the curved return sections C by the scoop 832, improving the smoothness of the return motion of the rollers 7.

To sum up the abovementioned description, the roller screw mechanism of the present invention exactly can provide an effect of facilitating assembly and improving the smoothness of the return motion of the rollers.

While we have shown and described various embodiments in accordance with the present invention, it should be clear to those skilled in the art that further embodiments may be made without departing from the scope of the present invention.

What is claimed is:

1. A roller screw mechanism comprising:
a screw shaft formed on its outer surface with a helical groove having a V-shaped cross section;
a nut for cooperating with the screw shaft and being provided for insertion of the screw shaft, in an inner surface of the nut is formed a helical groove that is V-shaped in cross section and is aligned to the helical groove of the screw shaft, in the nut is defined a return path that is connected to both ends of the helical groove of the nut, whereby to form a complete circulation path, so that rollers can roll endlessly in the nut, serving as a motion-transmitting medium between the nut and the screw shaft;
wherein the return path includes a linear section and two curved return sections, the two curved return sections are joined to both ends of the linear section and the helical groove of the nut; the linear section axially extends into the nut, a cross section of the linear section is rectangular for enabling the rollers to roll thereon;
each of the two curved return sections is formed in a return piece and fixed at either end of the helical groove of the nut respectively, whereby to join the curved return sections to both ends of the helical groove of the nut, a cross section of the respective curved return sections is rectangular for enabling the rollers to roll thereon.

2. The roller screw mechanism as claimed in claim 1, wherein an axially extending rectangular fillister is formed in an outer surface of the nut, and a cap is arranged correspondingly to the rectangular fillister, so as to form the linear section of the circulation path between the rectangular fillister and the cap.

3. The roller screw mechanism as claimed in claim 1, wherein the nut is defined with two receiving grooves that are formed from the inside to the outside of the nut and located correspondingly to both ends of the helical groove, the receiving grooves are connected to the linear section of the return path, and the respective receiving grooves do not completely penetrate the nut, so as to form a stop portion at a conjunction between the receiving grooves and the inner surface of the nut, a cross section of the respective receiving grooves cooperates with the respective return pieces for enabling the respective return pieces to be inserted from outside into the receiving grooves, and the respective return pieces will be positioned after being stopped by the respective stop portions, thus enabling the curved return section of the respective return pieces to be connected to both ends of the linear section of the return path and to both ends of the helical groove of the nut.

4. The roller screw mechanism as claimed in claim 1, wherein the respective return pieces are formed at a conjunction between the curved return section and the helical groove of the nut with a protruding scoop that extends to the helical groove of the screw shaft, a tangent surface of the scoop is located in a direction of the tangent line of the helical groove of the screw shaft, so as to introduce the rollers into the curved return sections.

5. The roller screw mechanism as claimed in claim 2, wherein the rectangular fillister and the respective return pieces are located in the same straight line, so that the cap can straddle the respective return pieces, and the cap is used to fix the respective return pieces.

6. The roller screw mechanism as claimed in claim 5, wherein the respective return pieces are formed with a recess in which the cap is engaged.
